(19) United States
(12) Patent Application Publication
(10) Pub. No.: US 2010/0089539 A1
(43) Pub. Date: Apr. 15, 2010

(54) Cord lock

(76) Inventor: Peter Stone, Brooklyn, NY (US)

Correspondence Address: Peter STONE;1st floor, 310 Bay 11th Street, BROOKLYN, NY, 11228, US

(21) Appl. No.: 12/214,376

(22) Filed: Jun. 18, 2008

(51) Int. Cl. E06B 9/324

(52) U.S. Cl. 160/178.2

(57) ABSTRACT

A cord lock for a Venetian blind or a shade disclosed has a housing having two parallel sidewalls, an end wall, a downwardly facing surface of the ramp members is formed with a plurality of transverse ribs; an opening is formed by the sidewalls, the end wall and the downwardly facing surface of the ramp members; a separator extends between the end wall and the ramp members; a pulley roller is rotatably mounted on a shaft supported in the sidewalls; a cylindrical floating roller formed on its peripheral surface with a plurality of ribs extending in a direction parallel to own axis; a top of the opening through which lift cords may pass freely to the pulley roller and then through the opening and then through different sides of the separator and then be completed as free hanging ends of pull cords; pushing means placed on the housing and having a mechanical contact with the pull cords on spots facing to the end wall and pushing the pull cords towards the cylindrical floating roller permanently. The pushing means will secure the immediate locking of the cords if the pull cords were accidentally released or dropped.

### FIELD OF THE INVENTION

The present invention relates to a cord lock for a Venetian blind or a shade, such as a pleated shade, and more specifically to a lock for the lift cord of such Venetian blind or shade.

Well known cord locks have stationary pulley made from either plastic material or metal, and is either rotatably mounted or is fixed in a housing, and also have a floating serrated or knurled roller, which can move up and down in slots in the housing. The cords lifting and lowering the blind or shade passes between the stationary pulley and the floating roller. When the cords are to be locked in position the floating roller engaged by the cords travel upwardly with the cords, caused by the weight of the blind, and the cords becomes wedged between the floating roller and the stationary pulley. When the cords are pulled downwardly the floating roller drops away from the stationary pulley and cords, and the blind or shade is released.

The existing cord locks are operated manually by hand by pulling on the cords. A disadvantage of existing cord locks is that they do not lock the cords if the cords are accidentally released or dropped. In this case the blind slats will fall down sometimes unequally. This creates unnecessary complication, may result in injury to person or damage to the cords and takes time to fix.

It is an object of the present invention to provide a cord lock for a Venetian blind or shade that the blind slats will never fall down.

### SUMMARY OF THE INVENTION

Accordingly, it is a primary object to provide a cord lock that does not possess the disadvantages of like prior art devices.

It is another object of the invention to provide a cord lock that will lock the cords without damaging them.

It is yet another object of the invention to provide a cord lock that is easy to use.

In order to achieve the above and other objects a cord lock includes pushing means to achieve permanent pushing of the pull cords towards the floating serrated or knurled roller. The pushing means will secure the immediate locking of the cords if the pull cords were accidentally released or dropped.

### BRIEF DESCRIPTION OF THE DRAWINGS

This invention, together with further aspects, features and advantages thereof will be more clearly understood by considering the following description in conjunction with the accompanying drawings in which like elements bear the same reference numerals throughout the several views.

FIG. 1a to FIG. 1c is different stages of a longitudinal sectional view of cord lock according to the invention with pushing means having a gravity pusher in a case when someone controls the cord lifting/lowering process.

FIG. 2 is a view similar to FIG. 1 and shows how the gravity pusher operates in a case when someone accidentally releases or drops the cord while lifting/lowering process.

FIG. 3 is a perspective view of the gravity pusher.

FIG. 4 is a view similar to FIG. 1a with modified gravity pusher.

FIG. 5 is a perspective view of the modified gravity pusher.

FIG. 6a to FIG. 6c is different stages of a longitudinal sectional view of cord lock according to the invention with pushing means having a piston pusher and a spring in a case when someone controls the cord lifting/lowering process.

FIG. 7 is a view similar to FIG. 6 and shows how the piston pusher operates in a case when someone accidentally release or drops the cord while lifting/lowering process.

FIG. 8 is a perspective view of the piston pusher with the spring.

FIG. 9a to FIG. 9b is a longitudinal view and a fragmentary cross sectional view of cord lock according to the invention with pushing means having a pendulum pusher.

FIG. 10a to FIG. 10b and FIG. 11a to FIG. 11b is views similar to FIG. 9a to FIG. 9b show the different stages of the locking process with the pendulum pusher.

FIG. 12 is a perspective view of the pendulum pusher.

### DETAILED DESCRIPTION OF A PREFERRED EMBODIMENT

Referring to the drawings in detail, a cord lock 9 according to the present invention comprises a housing 10, which has two parallel sidewalls 11 and 11′, an end wall 12 and a downwardly facing surface 13 of ramp members 14 is formed with a plurality of transverse ribs 15. A pulley roller 16 is rotatably mounted on a shaft 17 supported in the sidewalls 11 and 11′ in proximity to an end strap 18 of the end wall 12.

Also disposed within the cord lock, there is provided a cylindrical floating roller 19 formed on its peripheral surface with a plurality of ribs 21 extending in a direction parallel to the axis of that roller. Elongated opening 41 are provided in the sidewalls 11 and 11′ and the end wall 12 and the downwardly facing surface 13 of ramp members 14. A separator 22, which is extend between the end wall 12 and the ramp 14 of housing 10 generally in alignment with a corner 23. The cylindrical floating roller 19 has such a length that it is free to move in any radial direction between the sidewalls 11 and 11′. The cylindrical floating roller 19 is prevented from passing through the opening 41 by the separator 22.

The cord lock 9 is disposed within an opening 51 in a header channel 52 and fixed by the separator 22.

The end strap 18 is disposed slightly outwardly relative to inner edges 42 and 42′ of the sidewalls 11 and 11′ to permit lift cords 31 and 31′ to pass freely to the pulley roller 16 and then through the opening 41 where the lift cords 31 and 31′ are split by separator 22. Pull cords 32 and 32′ hang outwardly and downwardly and are used for raising and lowering the blind slats.

According to the present invention the cord lock 9 is provided pushing means, which is mounted or is fixed inside or outside of the housing 10. The pushing means have a mechanical contact with the pull cords 32 and 32′ in spots facing to the end wall 12 of the housing 10 and have an ability to push the pull cords 32 and 32′ permanently towards the cylindrical floating roller 19.

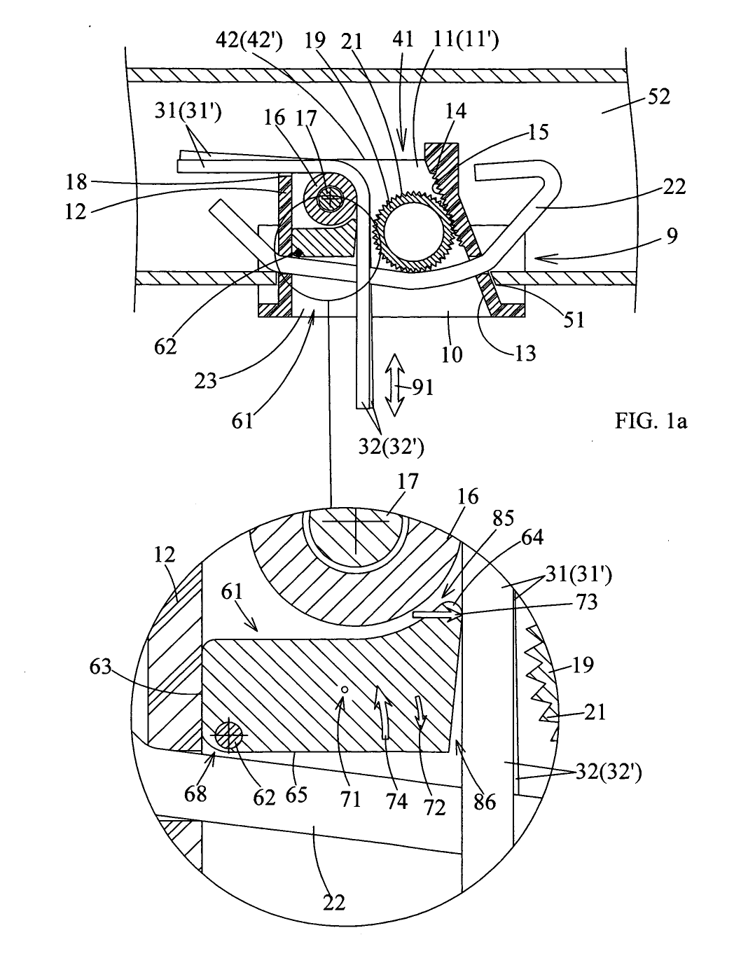

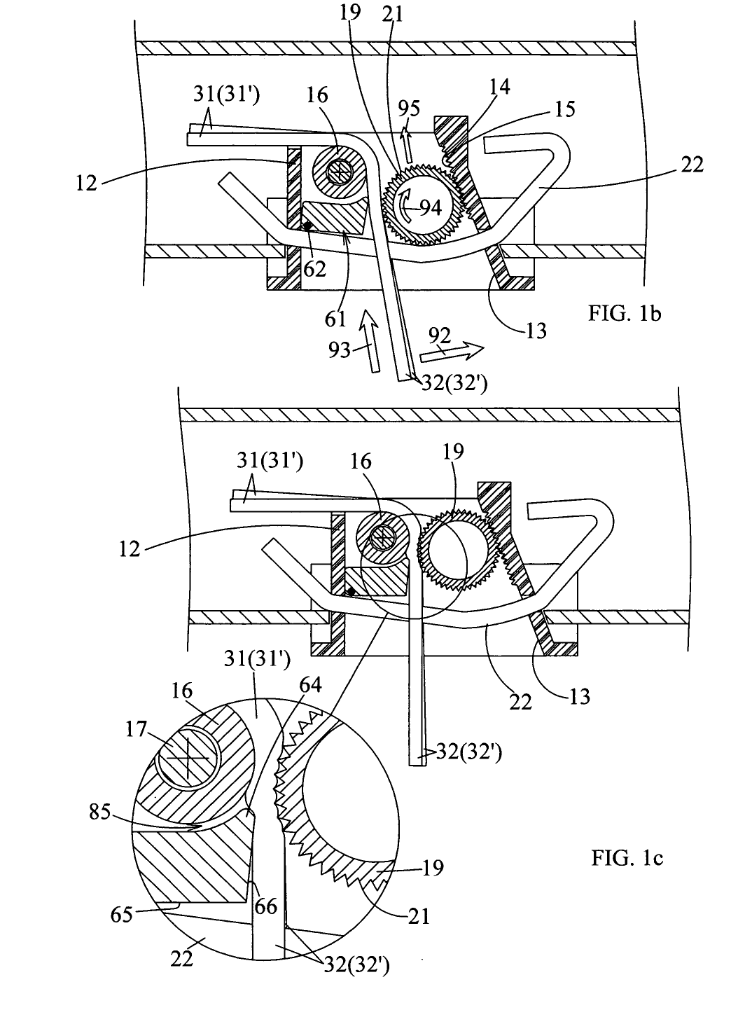

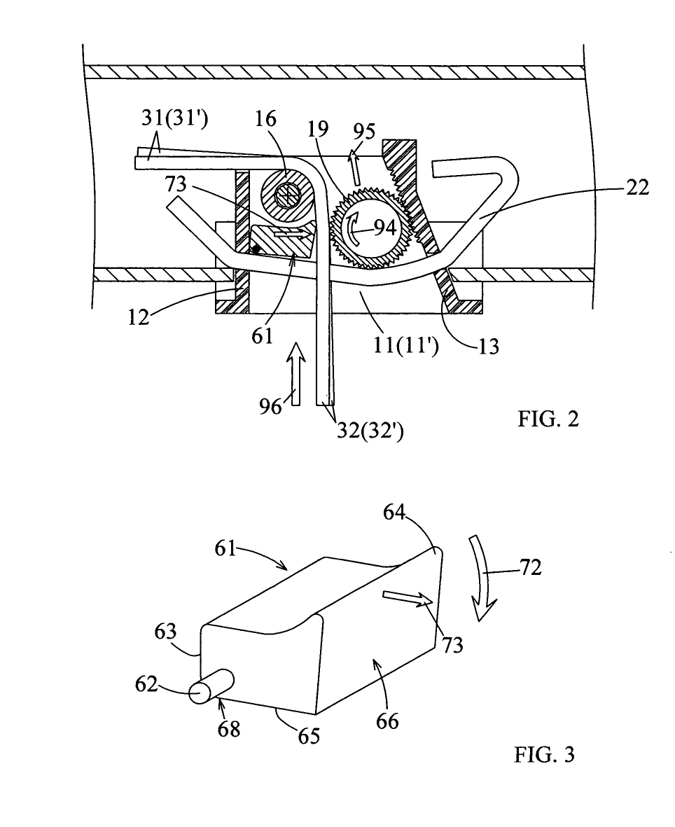

On FIG. 1 and FIG. 2 shown the cord lock with pushing means having a gravity pusher 61 which is pivotally mounted on a shaft 62 supported in the sidewalls 11 and 11′ in proximity to the end wall 12 between the pulley roller 16 and the separator 22. The shaft 62 is placed on a corner 68 of the gravity pusher 61 in proximity to the end wall 12 and the separator 22. The gravity pusher 61 has such a length that it is free to move in any rotary direction between the sidewalls 11 and 11′.

If the gravity pusher 61 is in upper position as shown on FIG. 1a a backside 63 of the gravity pusher 61 is in mechanical contact with the end wall 12 of housing 10 and a top face corner 64 of the gravity pusher 61 has a gap 85 with the pulley roller 16. If the gravity pusher 61 is in lower position as shown on FIG. 1b a bottom side 65 is not in mechanical contact with the separator 22.

A face side 66 of the gravity pusher 61 is not a parallel to the backside 63 so there is a gap 86 between the face side 66 and the pull cords 32 and 32′. As a result the top face corner 64 is in mechanical contact with the pull cords 32 and 32′ permanently. It creates a force moment by tension on cords 32 and 32′ shown by arrow 74 around to the shaft 62, which is always counter-clockwise.

A center of gravity 71 of the gravity pusher 61 does not coincide with a center of rotation of the gravity pusher 61 around the shaft 62. Due to that there is a permanent clockwise gravity moment shown by arrow 72 around to the shaft 62. The clockwise gravity moment 72 creates a pushing force shown by arrow 73, which pushes the pull cords 32 and 32′ permanently towards the cylindrical floating roller 19. Usually the moment 74 of tension on pull cords 32 and 32′ is hundreds time more then the gravity moment 72. Due to that with tension on the cords 32 and 32′ the gravity pusher 61 will always be in upper position as shown on FIG. 1a.

If the free hanging ends of the pull cords 32 and 32′ are pulled down to raise the blind slats by the lift cords 31 and 31′ the cylindrical floating roller 19 is to be in position shown on FIG. 1a. After this the blind slats can be moved up and down (as shown by two sides arrow 91).

If the free hanging ends of the pull cords 32 and 32′ are pulled aside (as shown on FIG. 1b by arrow 92) and then tension on the these cords is released slightly to allow the slats to fall a short distance under the effect of gravity (as shown by arrow 93), engagement of the pull cords 32 and 32′ with the cylindrical floating roller 19 will cause that roller to engage the ramp 14 and the resulting rotation of the cylindrical floating roller 19 will in turn cause it to move upwardly along that ramp by virtue of the engagement of the ribs 21 on the cylindrical floating roller 19 with the ribs 15 on the ramp 14 (as shown by arrows 94 and 95 respectively). Such upward movement will continue until the cylindrical floating roller 19 is in the position shown in FIG. 1c in which it serves to clamp the pull cords 32 and 32′ between the pulley roller 16 and the cylindrical floating roller 19. This then prevents any further upward movement of the pull cords 32 and 32′ and consequently any further lowering of the blind slats (not shown).

Different action will accrue inside of the cord lock with gravity pusher 61 if in unlocked cords position shown on FIG. 1a the pull cords 32 and 32′ will be accidentally released or dropped. In this case there is no tension on the pull cords 32 and 32′ and pusher force 73 will be the only force, which will push the pull cords 32 and 32′ towards the cylindrical floating roller 19 as shown on FIG. 2. It is inevitable the slats to fall a short distance (as shown by arrow 96) under the effect of gravity to wedge the pull cords 32 and 32′ between the pulley roller 16 and the cylindrical floating roller 19 as shown on FIG. 1c. It will be done automatically.

As shown on FIG. 1c a contact surface between the pull cords 32 and 32′ and the pulley roller 16 and the cylindrical floating roller 19 and the top corner 64 and the top face side 66 of the gravity pusher 61 will be increased comparative with one of the priority arts cord locks. As a result a damage of the cords will be reduced.

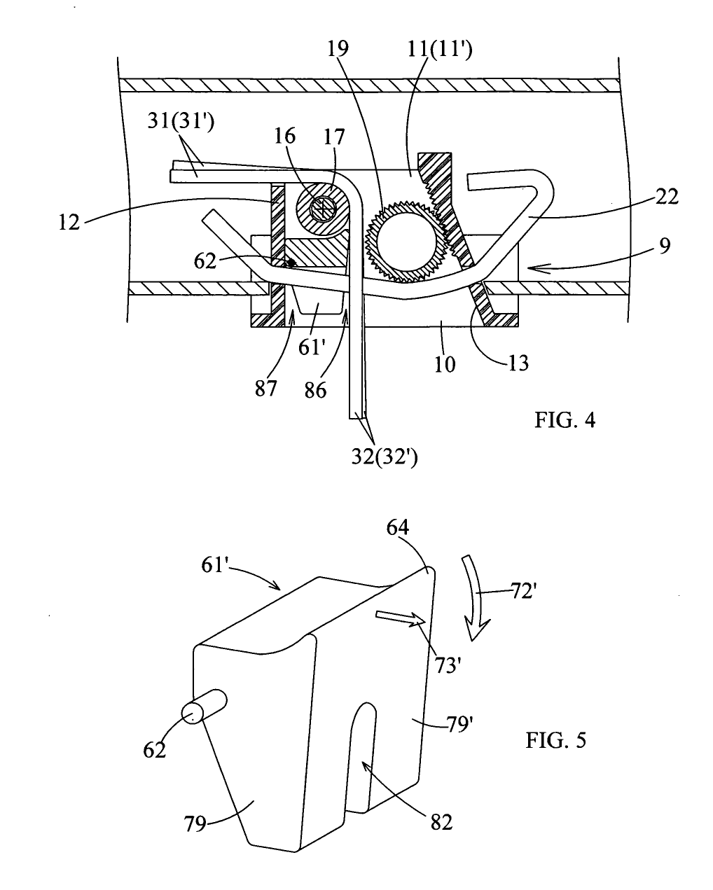

Shown on FIG. 3 the gravity pusher 61 can be modified by adding parts 79 and 79′ to the bottom side 65 with a gap 82 as shown on FIG. 5. As shown on FIG. 4 there is a gap 87 between the end wall 12 and the parts 79 and 79′ for any position of the modified gravity pusher 61′. A gravity moment 72′ and a pushing force 73′ of modified gravity pusher 61′ is greater then ones for the gravity pusher 61.

To increase a sensitivity of the modified gravity pusher 61′ by reducing a friction between the gravity pusher and different parts of the housing 10 during any motion, the length of the gravity pusher 61′ and a distance between the sidewalls 11 and 11′ and the diameter of the separator 22 and a size of the gap 82 are chosen that the gravity pusher 61′ has mechanical contact with the separator 22 only.

Preferably material for the gravity pusher is metal like bronze or steel.

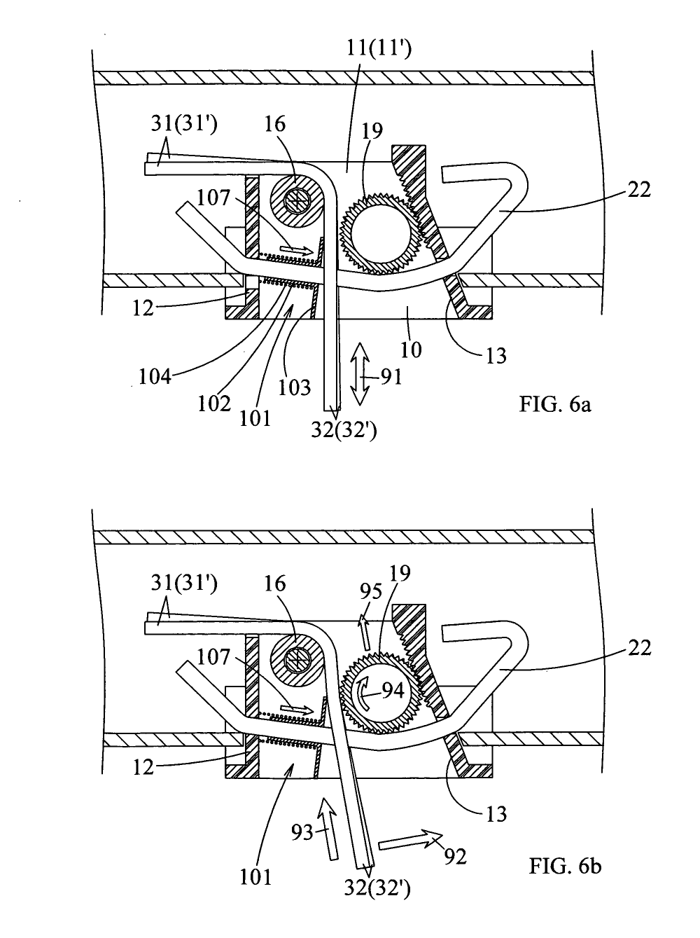

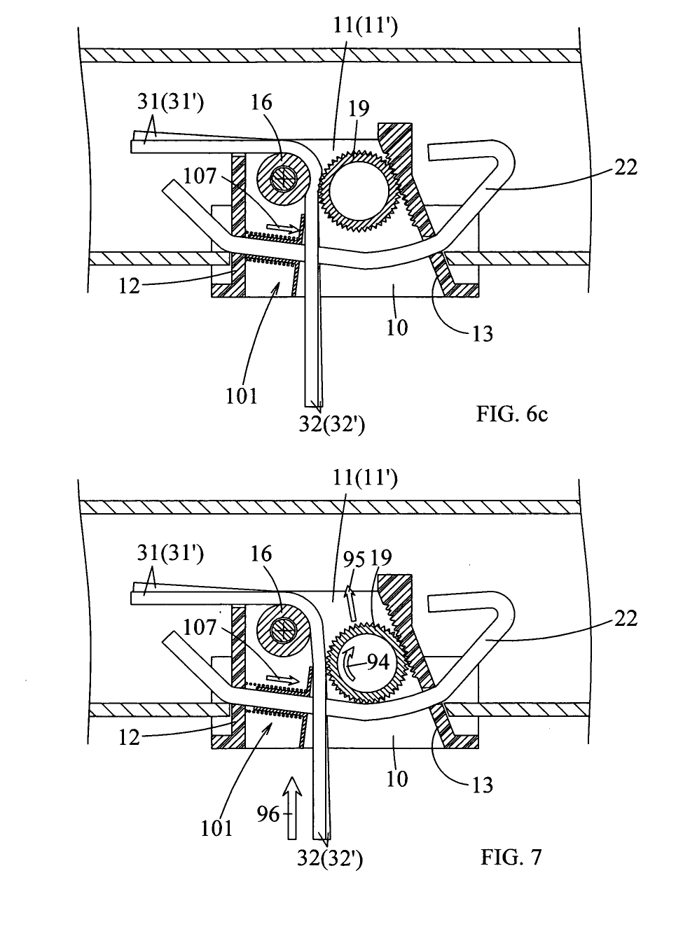

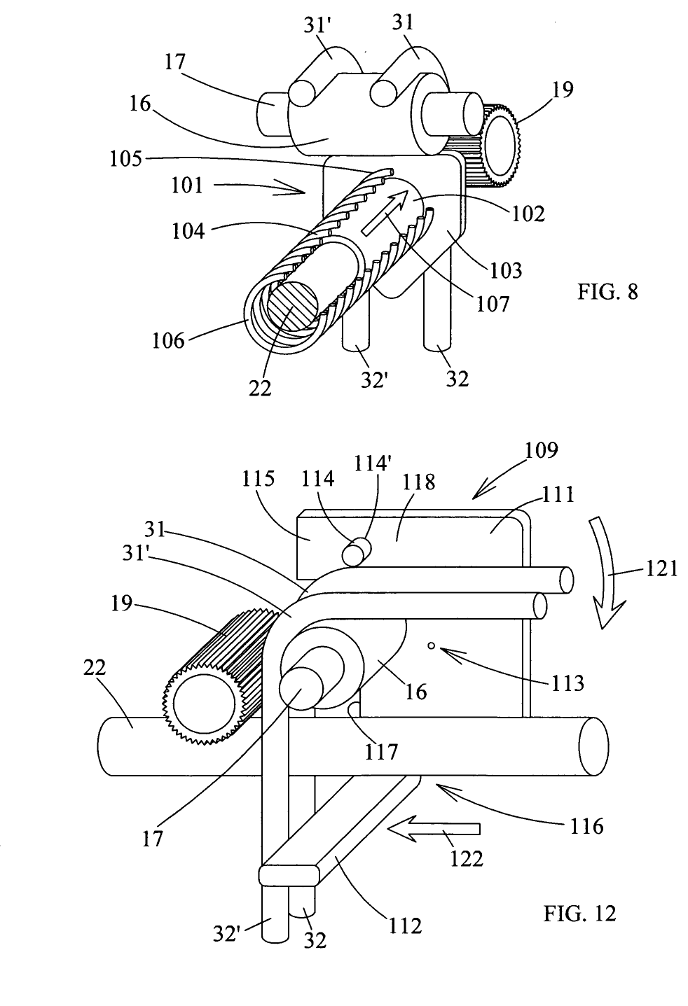

On FIG. 6 and FIG. 7 shown the cord lock with pushing means having a piston pusher 101 and a spring 104, which is moveably mounted on the separator 22 in proximity to the end wall 12 under the pulley roller 16. As shown on FIG. 8 the piston pusher 101 consist of a tube 102 and a piston plate 103 as one solid body. One end 105 of the spring 104 is in mechanical contact with the piston plate 103 and another one 106 with the end wall 12 of the housing 10. The piston plate 103 and the tube 102 has such a shape and sizes that the piston pusher 101 is free to move alone the separator 22 between the sidewalls 11 and 11′ under the pulley roller 16. The piston pusher 101 is in mechanical contact with the pull cords 32 and 32′ and permanently pushes them towards the cylindrical floating roller 19 (as shown by arrow 107).

The level of pushing force and a nature of the piston pusher acting is the same as for the gravity pusher.

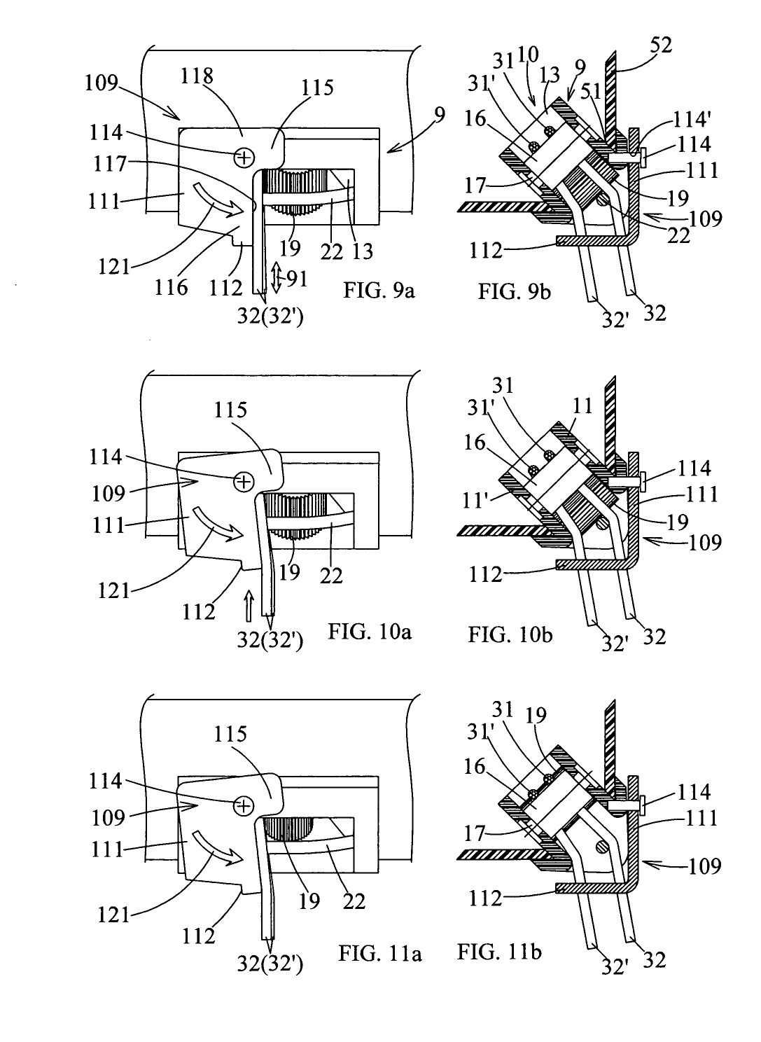

On FIG. 9 to FIG. 11 shown the cord lock with pushing means having a pendulum pusher 109, which is pivotally mounted on a pin 114 outside of the cord lock 9. The pendulum pusher 109 has a plate 111 and a finger 112. The finger 112 is attached to the plate 111 in a bottom corner 116 of a side 117 of the plate 111. As shown on FIG. 12 a hole 114′ to engage with the pin 114 is placed on the same side 117 but in a top corner 118 of the plate 111. The finger 112 is designed to have a permanent mechanical contact with the pull cords 32 and 32′. A center of gravity 113 of the pendulum pusher 109 does not coincide with a center of rotation the pendulum pusher 109 around the pin 114. Due to that there is a permanent clockwise pendulum moment shown by arrow 121 around to the pin 114. This moment creates a pushing force shown by arrow 122, which is permanently pushes the pull cords 32 and 32′ towards the cylindrical floating roller 19. A part of 115 of the plate 111 stabilizes a rotating motion of the pendulum pusher 109. The plate 111 and the finger 112 can be made as one solid body as well.

Preferably material for the pendulum pusher is metal like bronze or steel.

The level of pushing force and a nature of the pendulum pusher acting is the same as for the gravity and piston pushers.

While the invention has been described with reference to illustrative embodiments, it is not intended that the novel device be limited thereby, but that modifications thereof are intended to be included within the broad spirit and scope of the disclosure and the following claims and the appended drawings.

I claim:

1. A cord lock for a Venetian blind or a shade comprising: a housing having two parallel sidewalls, an end wall, a downwardly facing surface of the ramp members is formed with a plurality of transverse ribs; an opening is formed by said sidewalls, said end wall and said downwardly facing surface of said ramp members; a separator extends between said end wall and said downwardly facing surface of said ramp members; a pulley roller is rotatably mounted on a shaft supported in said sidewalls in proximity to said end wall; a cylindrical floating roller formed on its peripheral surface with a plurality of ribs extending in a direction parallel to own axis and having a length, which allows said cylindrical floating roller free moves in any radial direction between said two sidewalls; a top of said opening through which lift cords may pass freely to said pulley roller and then through said opening and then through different sides of said separator and then be completed as free hanging ends of pull cords; pushing means placed on said housing and having a mechanical contact with said pull cords on spots facing to said end wall and pushing said pull cords towards said cylindrical floating roller permanently.

2. A cord lock as defined in claim 1, wherein said pushing means comprising a gravity pusher pivotally mounted on a shaft supported in said sidewalls in proximity to said end wall between said pulley roller and said separator, and having a center of gravity, which is not coincide with said shaft, and having a length, which allows it freely move in any rotary direction between said sidewalls, and having a mechanical contact with said pull cords,

3. A cord lock as defined in claim 2, wherein said gravity pusher comprising a top face corner, having a gap with said pulley roller when said gravity pusher is in it upper position, and having a mechanical contact with said pull cords when said gravity pusher is in it any position, a backside having a mechanical contact with said end wall when said gravity pusher is in it upper position, a bottom side having no mechanical contact with said separator when said gravity pusher is in it lower position.

4. A cord lock as defined in claim 3, wherein said gravity pusher comprising two parts attached to said bottom side with a gap between said two parts more then a diameter of said separator, said length of said gravity pusher, said distance between said sidewalls, said diameter of said separator and said gap between said two parts having parameters which allows said gravity pusher freely move in any rotary direction between said sidewalls and said separator.

5. A cord lock as defined in claim 1, wherein said pushing means comprising a piston pusher and a spring both moveably mounted on said separator in proximity to said end wall so that one end of said spring is in mechanical contact with said end wall, another end of said spring is in mechanical contact with said piston pusher, and said piston pusher having permanent mechanical contact with said pull cords.

6. A cord lock as defined in claim 5, wherein said piston pusher comprising a tube and a piston plate as one solid body, said tube and said piston plate having such a shape and sizes allows said piston pusher freely move alone said separator between said sidewalls under said pulley roller.

7. A cord lock as defined in claim 1, wherein said pushing means comprising a pendulum pusher pivotally mounted on a pin outside of said housing having a center of gravity, which is not coincide with said pin, and having a mechanical contact with said pull cords.

8. A cord lock as defined in claim 7, wherein said pendulum pusher comprising a plate, a finger placing on a side bottom corner of said plate and having permanent contact with said pull cords, a hole to engage with said pin placing on a top corner of said side of said plate, an addition plate placing on said top corner of said side of said plate, wherein said plate, said finger and said addition plate made up as one solid body.
